(19) United States
(12) Patent Application Publication
(10) Pub. No.: US 2025/0339785 A1
(43) Pub. Date: Nov. 6, 2025

(54) ACCESSORY, INFLATABLE DOLL, AND INFLATABLE DOLL SET

(71) Applicant: COMIN INTERNATIONAL INC, CITY OF INDUSTRY, CA (US)

(72) Inventor: YUMIN GU, CITY OF INDUSTRY, CA (US)

(21) Appl. No.: 19/269,050

(22) Filed: Jul. 15, 2025

Related U.S. Application Data
(63) Continuation-in-part of application No. 18/762,662, filed on Jul. 3, 2024.
Application No. 18/762,662 is a continuation-in-part of application No. 18/460,534, filed on Sep. 2, 2023, now Pat. No. 12,070,699.
Application No. 18/460,534 is a continuation-in-part of application No. 18/195,373, filed on May 10, 2023.
Application No. 18/195,373 is a continuation-in-part of application No. 17/828,061, filed on May 31, 2022, now Pat. No. 11,691,088.

(51) Int. Cl. A63H 3/06; A63H 3/00; A63H 3/28; A63H 3/36; A63H 13/00

(52) U.S. Cl. CPC A63H 3/06; A63H 3/003; A63H 3/28; A63H 3/36; A63H 13/00; A63H 3/006; A63H 2200/00

(57) ABSTRACT

The present disclosure provides an accessory, an inflatable doll, and an inflatable doll set. The accessory includes at least one first air blower and an AI assembly. The first air blower includes a first air inlet portion and a first air outlet portion communicated with the first air inlet portion and the inflatable doll. The AI assembly is electrically connected to the first air blower and configured to control the at least one first air blower to inflate or deflate the inflatable doll.

### CROSS-REFERENCE TO RELATED APPLICATIONS

This application relates to and claims priority from the following U.S. patent applications. This application is a continuation-in-part of application Ser. No. 18/762,662 filed Jul. 3, 2024, which is a continuation-in-part of application Ser. No. 18/460,534 filed Sep. 2, 2023, which is a continuation-in-part of application Ser. No. 18/195,373 filed May 10, 2023, which is a continuation-in-part of application Ser. No. 17/828,061 filed May 31, 2022 and issued as U.S. Pat. No. 11,691,088, each of which is hereby incorporated by reference in its entirety.

### FIELD

The present disclosure relates to the field of dolls, and in particular to an accessory, an inflatable doll having the accessory, and an inflatable doll set.

### BACKGROUND

Supermarkets or amusement parks use inflatable dolls to create a friendly atmosphere to attract customers. However, the existing inflatable dolls have a single dynamic movement and are less attractive to customers. Thus, the present invention provides an inflatable doll that can solve the above problem.

### SUMMARY

The present disclosure provides an accessory which can be applied to an inflatable doll. The accessory includes at least one first air blower and an AI assembly. The first air blower includes a first air inlet portion and a first air outlet portion communicated with the first air inlet portion and the inflatable doll. The AI assembly is electrically connected to the first air blower and configured to control the at least one first air blower to inflate or deflate the inflatable doll.

The present disclosure further provides an inflatable doll which includes a body having a cavity, and an accessory. The accessory includes at least one first air blower and an AI assembly. The first air blower includes an air inlet portion and an air outlet portion communicated with the air inlet portion and the cavity. The AI assembly is electrically connected to the first air blower and configured to control the at least one first air blower to inflate or deflate the inflatable doll.

The present disclosure further provides an inflatable doll set which includes a plurality of inflatable dolls, each inflatable doll includes body having a cavity, and an accessory. The accessory includes at least one first air blower and an AI assembly. The first air blower includes an air inlet portion and an air outlet portion communicated with the air inlet portion and the cavity. The AI assembly is electrically connected to the first air blower and configured to control the at least one first air blower to inflate or deflate the inflatable doll.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structural schematic view of an inflatable doll in an inflated state according to an embodiment of the present disclosure.

FIG. 2 is a structural schematic view of the inflatable doll of FIG. 1, wherein the inflatable doll bows to pay respect.

FIG. 3 is a structural schematic view of the inflatable doll of FIG. 1, wherein the inflatable doll twists to the left.

FIG. 4 is a structural schematic view of the bottom of the body and the connecting member of the inflatable doll of FIG. 1.

FIG. 5 is a structural schematic view of the accessory of the inflatable doll of FIG. 1.

FIG. 6 is an exploded view of the accessory in FIG. 5.

FIG. 7 is a structural schematic view of the connecting member in FIG. 6.

FIG. 8 is a structural schematic view of the first air blower in FIG. 6 according to an embodiment.

FIG. 9 is another structural schematic view of the first air blower in FIG. 8.

FIG. 10 is a structural schematic view of the first air blower in FIG. 6 according to another embodiment.

FIG. 11 is an exploded view of the lamp in FIG. 6.

FIG. 12 is another exploded view of the lamp in FIG. 6.

FIG. 13 is an enlarged view of portion A in FIG. 12.

FIG. 14 is a structural block diagram of the inflatable doll in FIG. 1.

FIG. 15 is a structural schematic view of an expandable member of the inflatable doll in FIG. 1.

FIG. 16 is a structural schematic view of another expandable member of the inflatable doll in FIG. 1.

FIG. 17 is a structural schematic view of a further expandable member of the inflatable doll in FIG. 1.

FIG. 18 is a structural schematic view of another expandable member of the inflatable doll in FIG. 1.

FIG. 19 is a structural schematic view of the second air blower of the inflatable doll in FIG. 1.

FIG. 20 is a structural schematic view of the second air blower and a portion of the expandable member.

FIG. 21 is another structural schematic view of the second air blower and a portion of the expandable member.

FIG. 22 is a structural schematic view of the accessory according to another embodiment.

FIG. 23 is a structural block diagram of AI assembly of the inflatable doll in FIG. 1.

FIG. 24 is a structural block diagram of the accessory of the inflatable doll according to another embodiment.

FIG. 25 is a structural schematic view of an inflatable doll in an inflated state according to a second embodiment of the present disclosure.

FIG. 26 is an exploded view of the inflatable doll in FIG. 25.

FIG. 27 is a structural schematic view of an inflatable doll set in an inflated state according to an embodiment of the present disclosure.

FIG. 28 is a structural schematic view of the accessory according to another embodiment.

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

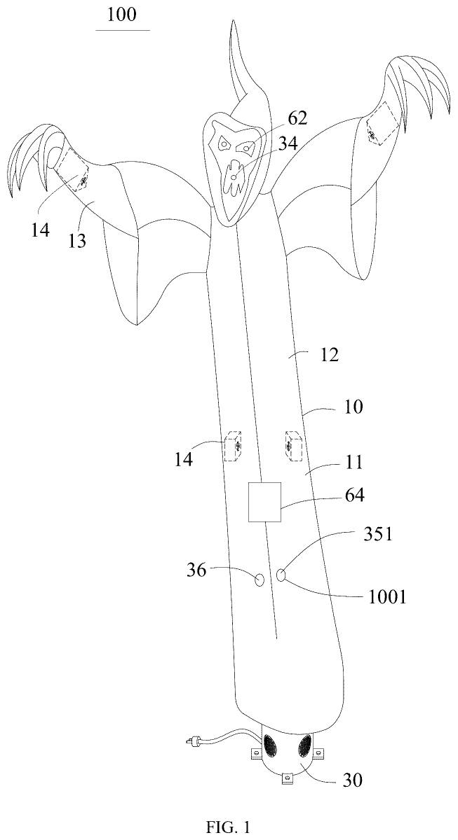

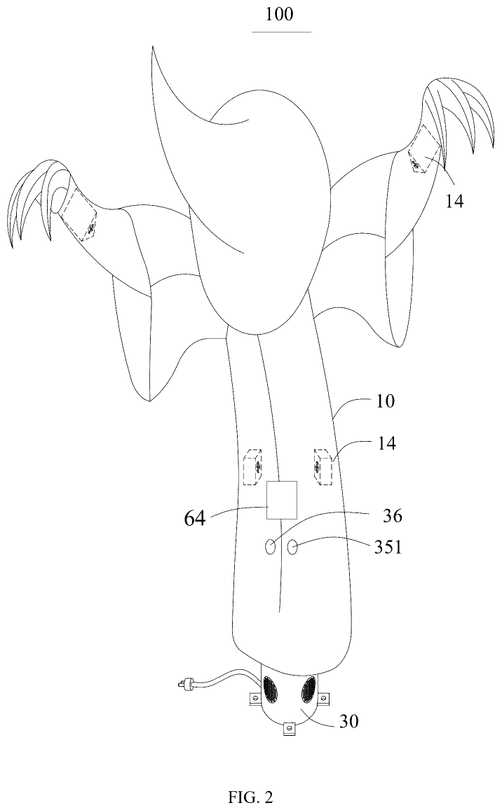

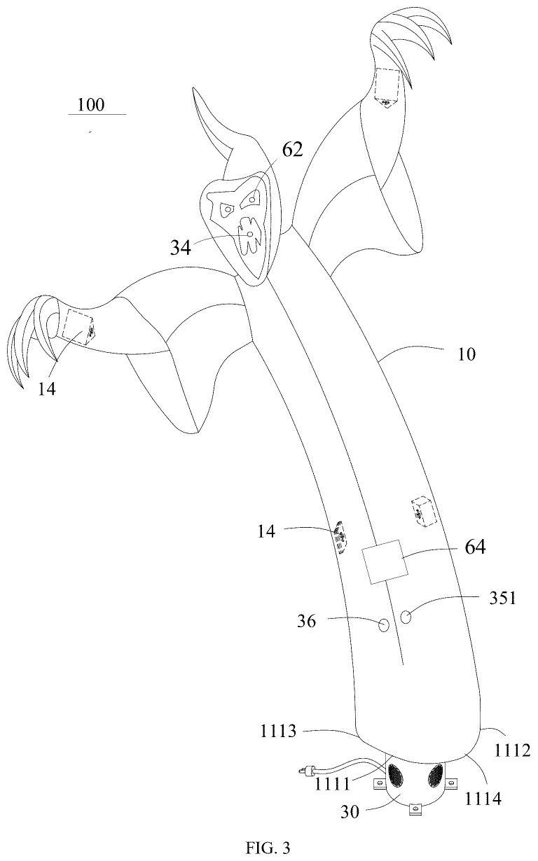

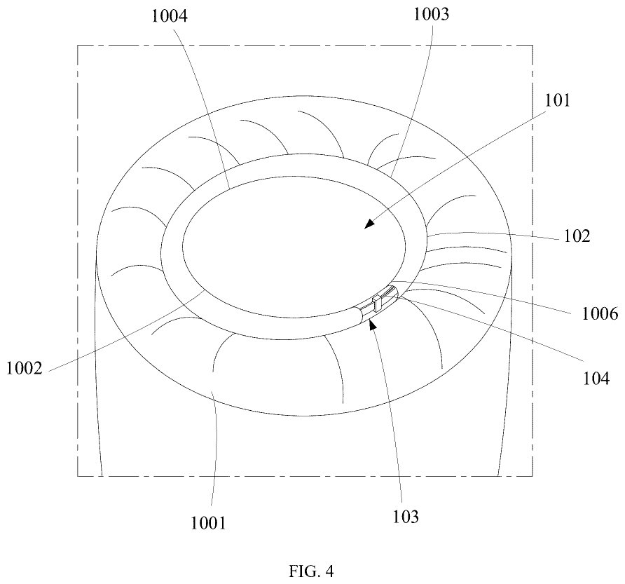

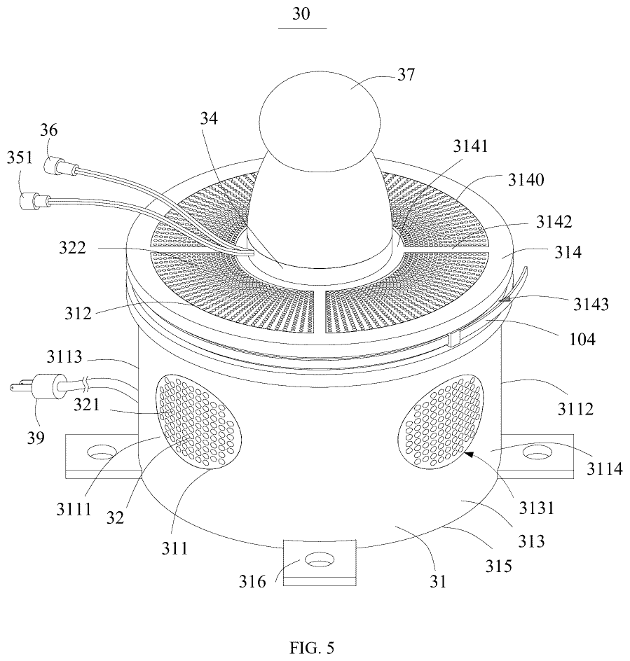

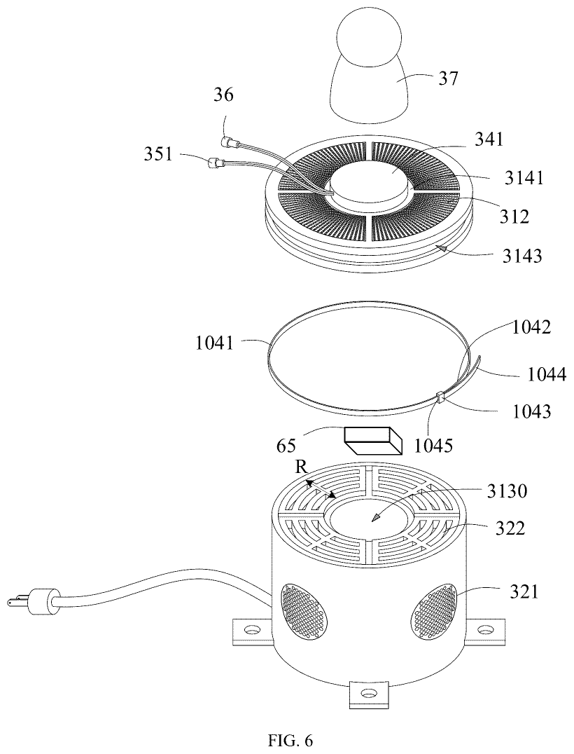

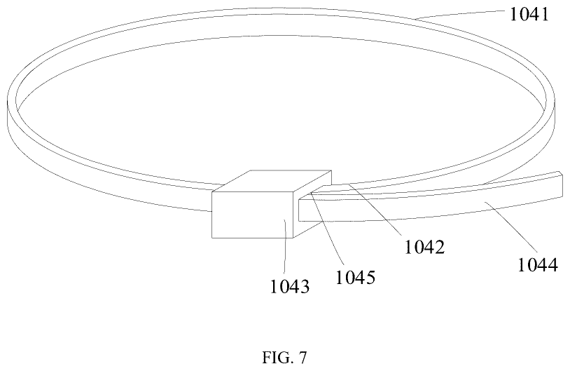

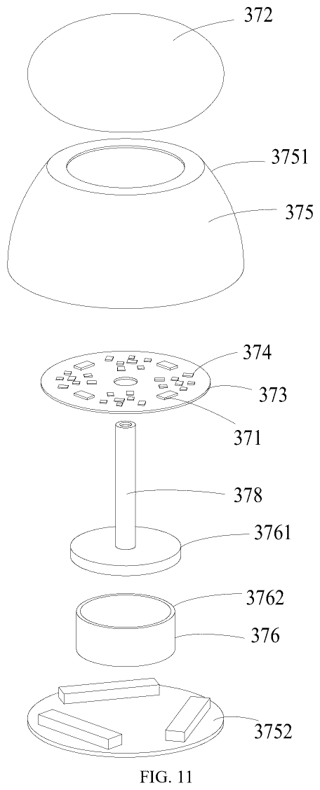

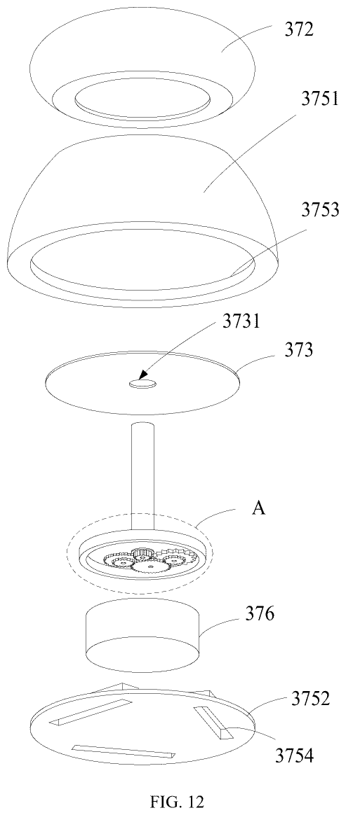

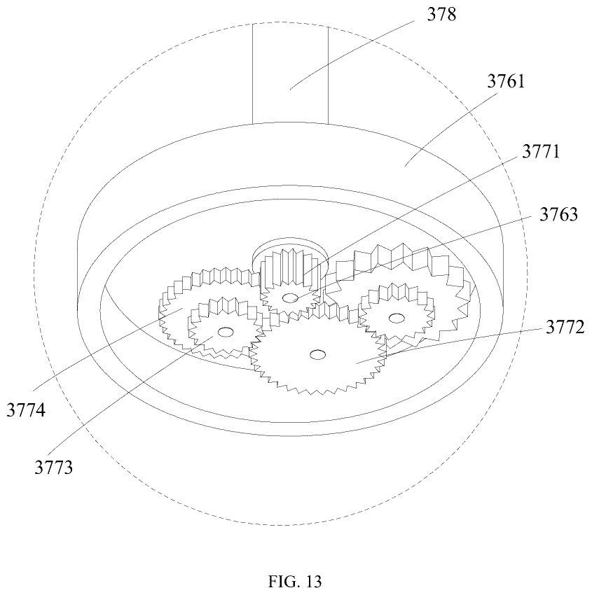

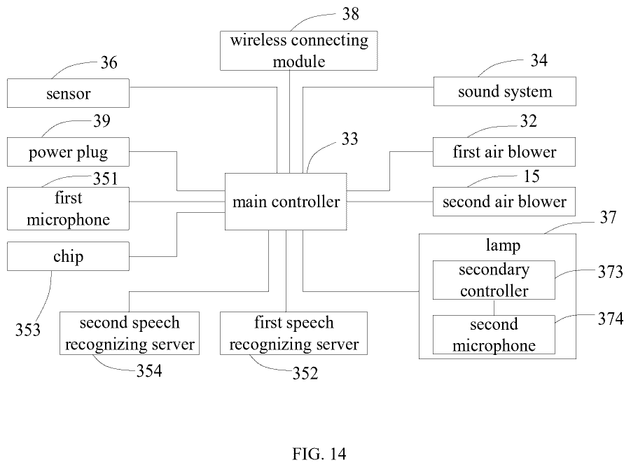

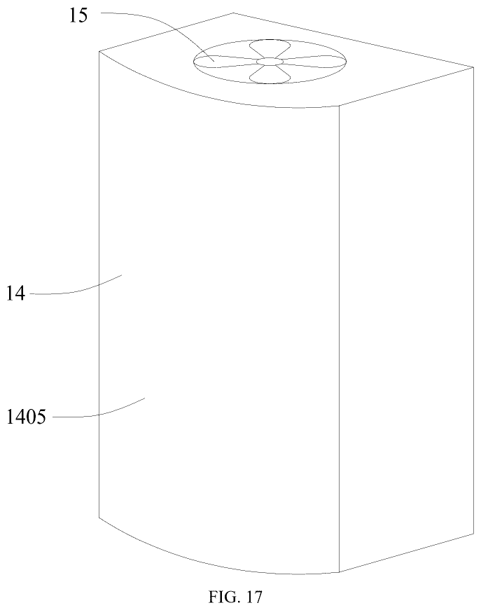

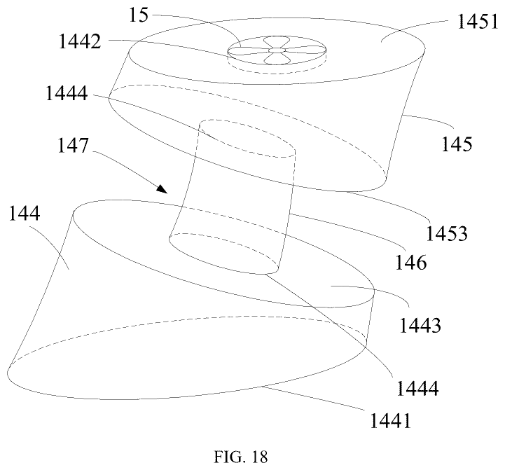

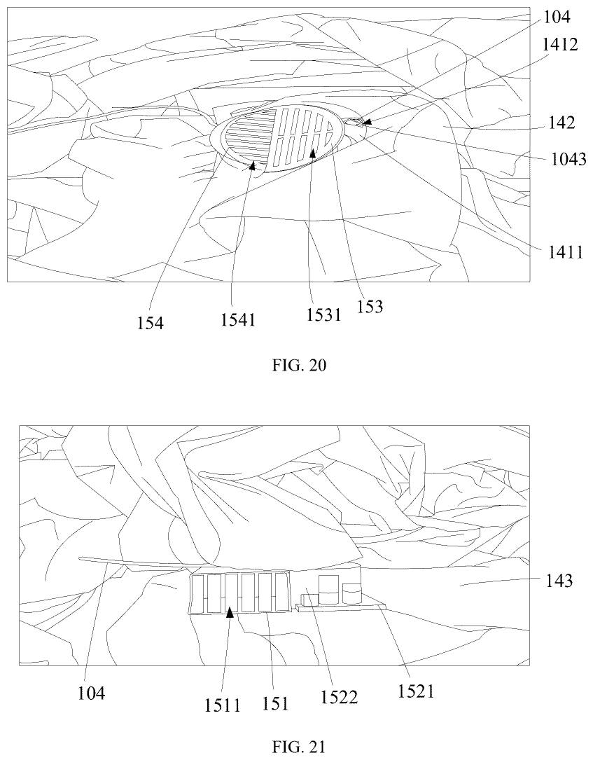

Referring to FIGS. 1-21, the present disclosure provides an inflatable doll 100 according to an embodiment. The inflatable doll 100 includes a body 10 with a cavity 11 and an accessory 30 connected with the body 10. The accessory 30 includes a housing 31, a plurality of first air blowers 32, and a main controller 33, and the housing 31 is used to mount the first air blowers 32 and the main controller 33. The housing 31 can be made of plastic, metal, wood, etc., and the housing 31 is substantially rigid. The housing 31 includes a first air inlet portion 311 and a first air outlet portion 312, the first air inlet portion 311 and the first air outlet portion 312 are both communicated with the cavity 11. The first air blowers 32 are at least partially mounted in the housing 31, and each first air blower 32 includes a second air inlet portion 321 and a second air outlet portion 322, and the second air inlet portion 321 and the second air outlet portion 322 are both communicated with the cavity 11, the second air inlet portion 321 of each first air blower 32 is communicated with the first air inlet portion 311, the second air outlet portion 322 of each first air blower 32 is communicated with the first air outlet portion 312. The main controller 33 is accommodated in the housing 31, the main controller 33 has an integrated circuit, and is electrically connected with the first air blowers 32 and configured to control at least one first air blower 32 of first air blowers 32 to direct air into the cavity 11 through the first air outlet portion 312 and the second air outlet portion 322. Under the control of the main controller 33, at least one first air blower 32 of the first air blowers 32 can work independently, and at least two first air blowers 32 of the first air blowers 32 can work simultaneously or independently. The accessory 30 further includes a power plug 39 arranged on the housing 31, the power plug 39 is electrically connected with the main controller 33, and the power plug 39 can be connected to an external power source to supply power to the first air blowers 32 and the main controller 33.

The body 10 includes a main part 12 and a secondary part 13 connected and communicated with the main part 12. In one embodiment, the inflatable doll 100 is a ghost doll, the main part 12 includes head, neck, abdomen, and legs, etc., and the secondary part 13 includes hands, arms, sleeves, etc. In other embodiments, the inflatable doll 100 may be a dinosaur doll, a human doll, a car doll, a rabbit doll, and so on.

The main controller 33 can control the first air blowers 32 to start or stop simultaneously, and can control at least one of the first air blowers 32 to work independently, and can also control at least two of the first air blowers 32 to work independently or simultaneously. For example, the main controller 33 can control one of the first air blowers 32 to start, and control another one of the first air blowers 32 to stop. The body 10 is disposed on the accessory 30, and the first air blowers 32 inflate the cavity 11 of the body 10 to make the body 10 expand and stand upright. The main controller 33 can control at least one of the first air blowers 32 to start to inflate the body 10. The main controller 33 can also control all of the first air blowers 32 to start simultaneously, so as to improve the inflation efficiency. The main controller 33 can control at least one first air blower 32 of the first air blowers 32 to stop, and the portion of the body 10 corresponding to the at least one first air blower 32 is deflated and deformed, and the main controller 33 can further control the at least one first air blower 32 of the first air blowers 32 to start working, and the portion of the body 10 corresponding to the at least one first air blower 32 is inflated and deformed again, the inflation and deflation operations are repeated, and the inflatable doll 100 can move dynamically. The first air blowers 32 are arranged at different positions of the housing 31 in a circumferential direction of the housing 31, the bottom of the body 10 is arranged on the accessory 30, such that the first air blowers 32 are also arranged corresponding to different portions of the bottom of the body 10. In one embodiment, the first air blowers 32 include a front first air blower located in a front portion 3111 of the housing 31, a rear first air blower located in a rear portion 3112 of the housing 31, a left first air blower located in a left portion 3113 of the housing 31, and a right first air blower located in a right portion 3114 of the housing 31, the front first air blower corresponds to the front portion 1111 of the body 10, the rear first air blower corresponds to the rear portion 1112 of the body 10, and the left and right first air blowers correspond to the left portion 1113 and the right portion 1114 of the body 10 respectively. When the inflatable doll 100 needs to perform actions such as dancing, the main controller 33 controls the front first air blower to stop working, and the air in the front portion 1111 of the body 10 flows out and the front portion 1111 of the body 10 deforms; then the controller 33 controls the front first air blower to start working again, so as to direct air into the front portion 1111 of the body 10, and the front portion 1111 of the body 10 deforms again; the main controller 33 controls the rear first air blower, the left first air blower, and the right first air blower to stop working or start working; the main controller 33 controls the first air blowers 33 to stop working and start working repeatedly, and the inflatable doll 100 can act dynamically to attract customers. Under the control of the main controller 33, the inflatable doll 100 can move left and right, move up and down, move forward and backward, twist, shake, nod, etc., and these actions can be symmetrical or asymmetrical. According to the actual needs, the body 10 can perform the above actions under the action of the main controller 33.

The first air blowers 33 may be bi-direction, and the main controller 33 can control the first air blowers 33 to direct air into the body 10 through the through hole 101, and can also control the first air blowers 33 to direct air out of the body 10 through the through hole 101. In this way, the inflatable doll 100 can act dynamically faster.

The bottom 1002 of the inflatable doll 100 has some sections, including the front section 1003, the back section 1004, the left section 1005 and the right section 1006, etc., the first air blowers 33 correspond to different sections of the bottom 1002 of the inflatable doll 100. In this way, the first air blowers 32 can inflate and deflate different portions of the inflatable doll 100 denamicaly. The first air blowers 33 are arranged along the circumference of the housing 31, so as to correspond to different portions of the inflatable doll 100. In detail, the first air outlet portions 312 and the second air outlet portions 322 are all arranged along the circumference of the housing 31. Further, first air outlet portions 312 and the second air outlet portions 322 are all arranged along the outer periphery of the housing 31.

The at least one first air outlet portion 312 defines at least one first via hole 3120, a total area of the at least one first via hole 3120 is two-fifths to four-fifths of an area of the an upper surface of the top cover 314, for example, the total area of the at least one first via hole 3120 is two-fifths, three-fifths, or four-fifths of the area of the upper surface of the top cover 314. The at least one second air outlet portion 322 defines at least one second via hole 3220, a total area of the at least one second via hole 3220 is two-fifths to four-fifths of an area of the an upper surface of the top cover 314, for example, the total area of the at least one second via hole 3220 is two-fifths, three-fifths, or four-fifths of the area of the upper surface of the top cover 314.

The body 10 is made of flexible material which can be inflated to expand and erect to a prearranged configuration and can also be deflated to perform different attractive actions. In detail, the body 10 is made of air-tight cloth, air-tight fabric, rubber, polyphthalamide, thermoplastic urethanes (TPU), polyphenylenesulfide-based fiber (PPS), polyetheretherketone-based fiber (PEEK), nylon, and the like wholly aromatic polyamide fiber, wholly aromatic polyester fiber, polyimide-based fiber, polyetherimide-based fiber, vinylon-based fiber, acrylic-based fiber, cellulose-based fiber, silicon carbide-based fiber, alumina-based fiber, glass-based fiber, carbon-based fiber, steel-based fiber, and the like. The body 10 may also be transparent or translucent.

The housing 31 includes a side wall 313, a top cover 314, and a bottom wall 315, and the side wall 313, the top cover 314 and the bottom wall 315 cooperatively form a receiving space 3130 for receiving the first air blowers 32 and the main controller 33. In one embodiment, the housing 31 may not have the bottom wall 315. The top cover 314 is detachably connected to the side wall 313, making it easy to change components in the housing 31. At least one fixing element 316 is arranged on the side wall 313 and/or the bottom wall 315, and the housing 31 is fixed on a platform such as the ground by the fixing element 316. The housing 31 can be in a regular shape or an irregular shape, and the regular shape includes cylinder, cuboid, cube, hexahedron, octahedron, and the like. The top cover 314 and the bottom wall 315 have shapes corresponding to the side walls 313. The side wall 313 defines the first air inlet portion 311. In one embodiment, the first air inlet portion 311 is a through hole which is opened in a circumferential direction of the side wall 313, and the through hole corresponds to the second air inlet portions 321, such that the air can flow into the body 10 smoothly, the through hole does not need to pass through the side wall 313 completely in the circumferential direction to divide the side wall 313 into two independent parts. In another embodiment, the first air inlet portion 311 includes a plurality of through holes spaced apart from each other, and each through hole corresponds to one corresponding second air inlet portion 321. In a further embodiment, the first air inlet portion 311 includes a plurality of mesh structures, each mesh structure defines at least one via hole, and each mesh structure corresponds to one corresponding second air inlet portion 321.

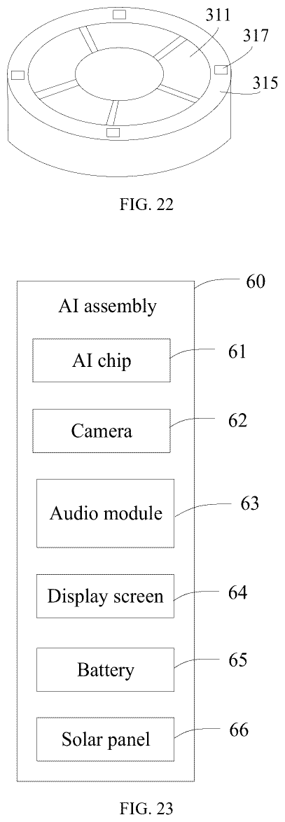

As shown in FIG. 22, in another embodiment, the bottom wall 315 can be isolated from the ground by at least one support feet 317, the first air inlet portion 311 can also be defined in the bottom wall 315, and air can be introduced into the body 10 from the first air inlet portion 311. The support feet 317 can have a certain height, and can be inserted into the ground to fix the housing 31. The first air inlet portion 311 can be a through hole which is opened in a circumferential direction of the bottom wall 315, and the through hole corresponds to the second air inlet portions 321; or the first air inlet portion 311 includes a plurality of through holes spaced apart from each other, and each through hole corresponds to one corresponding second air inlet portion 321; or the first air inlet portion 311 includes a plurality of mesh structures, each mesh structure defines at least one via hole, and each mesh structure corresponds to one corresponding second air inlet portion 321.

The first air outlet portion 312 and the second air outlet portion 322 are integrally formed in one body, or the first air outlet portion 312 is detachably connected with the second air outlet portion 322. The second air outlet portion 322 of the first air blower 32 is matched with the first air outlet portion 312 of the housing 31 in shape, the second air outlet portion 322 of the first air blower 32 and the first air outlet portion 312 of the housing 31 have a regular shape or an irregular shape, and the regular shape includes a fan shape, a round shape, a square shape, an oval shape, or a hexagonal shape, etc. The shape of the second air outlet portion 322 is arranged to match with the shape of the first air outlet portion 312, not only to acquire smooth deflation and inflation processes and improve deflation and inflation efficiencies, but also to enable the portion of the body 10 corresponding to the first air blower 32 to deform much more quickly and accurately. It should be understood that, the shape of the second air outlet portion 322 is arranged to match with the shape of the first air outlet portion 312, the deflation and inflation processes of each portion of the body 10 corresponding to the first air blower 32 will not be affected by the different shapes of the first air outlet 312 and the second air outlet 322, so as to improve the deformation accuracy of each portion of the body 10.

The housing 31 is provided with a plurality of first air blowers 32, specifically two to ten first air blowers 32, preferably four to eight first air blowers 32. The first air blowers 32 are disposed in the receiving space 3130 at intervals. In one embodiment, the housing 31 is in a hexahedron shape, and the side wall 313 has six surfaces correspondingly, each surface of the side wall 313 defines a through hole 3131, six first air blowers 32 are received in the receiving space 3130, and each first air blower 32 is communicated with or received in one corresponding through hole 3131. In another embodiment, the housing 31 is in a cylinder shape, the side wall 313 is in a circular shape correspondingly, the side wall 313 defines four through holes 3131 spaced apart from each other, four first air blowers 32 are received in the housing 31, and each first air blower 32 is communicated with or received in one corresponding through hole 3131. The shape of the housing 31 and the number of the first air blowers 32 can be set according to actual needs.

Each first air blower 32 includes a first casing 323 and a second casing 324, the first casing 323 is connected with the second casing 324 to form an accommodating space (not shown), components (not shown) configured to realize the function of directing air into the cavity 11, such as impeller, bracket, motor, pulley, coupling, muffler, bearing, etc., are accommodated in the accommodating space. The first casing 323 defines the second air inlet portion 321, and the second air inlet portion 321 may be a through hole or a mesh structure with through holes.

The first casing 323 can be integrally formed with the first air inlet portion 311 or the first air outlet portion 312, or the second air inlet portion 321 of the first casing 323 can be integrally formed with the first air inlet portion 311 or the first air outlet portion 312, and the second casing 324 is detachably connected with the first casing 323, to facilitate the preparation of the first casing 323 and the installation of the second casing 324 and the above described components. When the above described components need to be replaced, user can disassemble the second casing 324 from the first casing 323 for replacement. In another embodiment, the first casing 323 is detachably connected with the first air inlet portion 311, when the above described components need to be replaced, user can disassemble the first casing 323 from the first air inlet portion 311 for replacement.

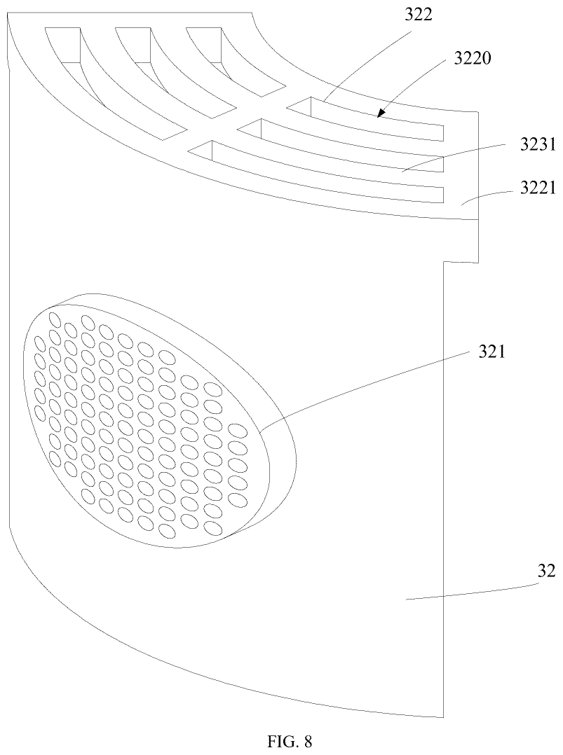

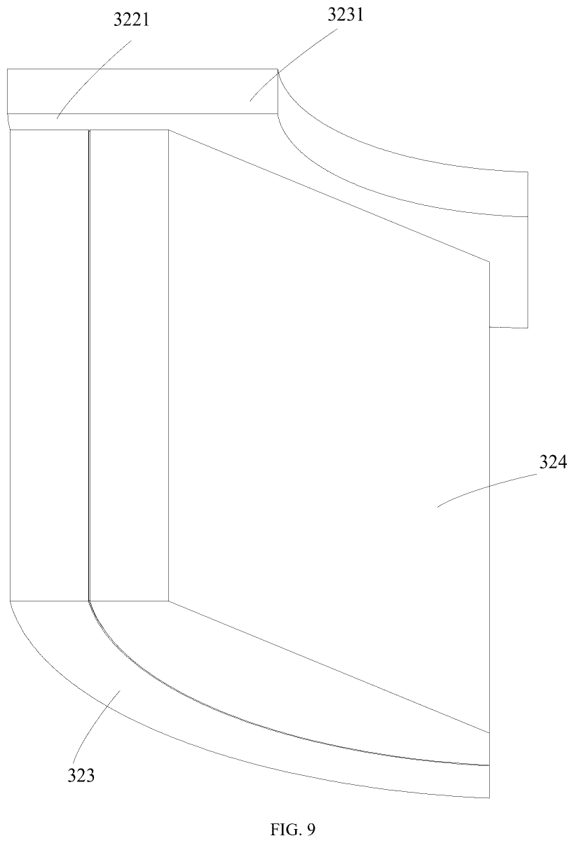

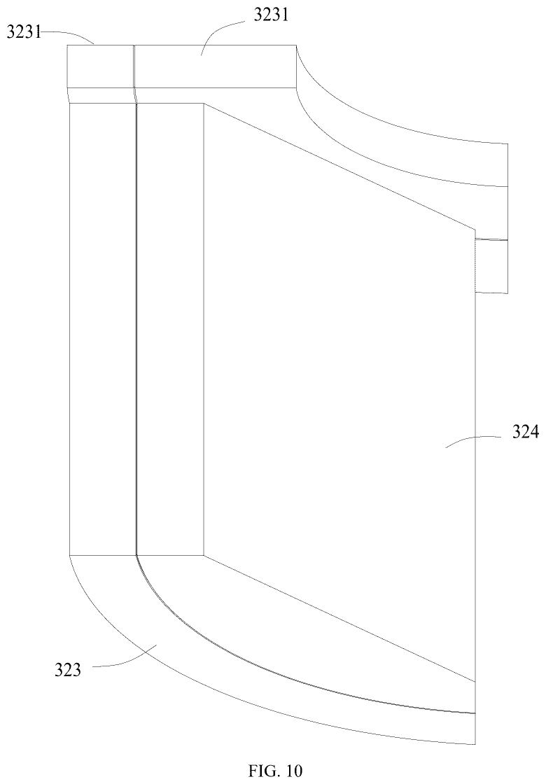

The first casing 323 and/or the second casing 324 includes a protruding portion 3231. In one embodiment, referring to FIGS. 8 and 9, the first casing 323 has the protruding portion 3231 which is protruded from the first casing 323 and the second casing 324, the protruding portion 3231 defines the second air outlet portion 322; in another embodiment, the second casing 324 has the protruding portion 3231 which is protruded from the first casing 323 and the second casing 324, the protruding portion 3231 defines the second air outlet portion 322; in a further embodiment, referring to FIG. 10, each of the first casing 323 and the second casing 324 have a protruding portion 3231, and the two protruding portions 3231 are detachably connected with each other, and the two protruding portions 3231 cooperatively define the second air outlet portion 322. The second air outlet portion 322 can be a through hole, or a mesh structure with at least one through hole. A periphery of the second air outlet portion 322 extends outwards to form a flange 3221, and the flange 3221 can be connected to an inner surface or an outer surface of the top cover 314. The second air inlet portion 321 and the second air outlet portion 322 are arranged in different directions. Specifically, the second air inlet portion 321 is arranged towards the side wall and substantially perpendicular to an axial direction of the housing 31, the second air outlet portion 322 is arranged towards the top cover 314 and substantially parallel to the axial direction of the housing 31, and the second air inlet portion 321 is arranged substantially perpendicular to the second air outlet portion 322. And, a first direction of air passing through the second air inlet portion 321 is substantially perpendicular to a second direction of air passing through the second air outlet portion 322. In another embodiment, the second air inlet portion 321 is arranged towards the bottom wall 315 and substantially parallel to the axial direction of the housing 31, the second air outlet portion 322 is arranged towards the top cover 314 and substantially parallel to the axial direction of the housing 31.

The second air inlet portion 321 faces towards the first air inlet portion 311, and the second air inlet portion 321 is arranged adjacent to and parallel with the first air inlet portion 311, to improve the air flow efficiency.

A radius R′ of the first air outlet portion 312 is substantially one-fifth to four-fifths of a radius of the housing 31. Specifically, the radius R′ of the first air outlet portion 312 is substantially one-fifth to four-fifths of the radius of the top cover 314, preferably two-fifths to four-fifths, for example, the radius R′is one-fifth, two-fifths, three-fifths, four-fifths of the radius of the top cover 31. A radius R′ of the second air outlet portion 332 can also be substantially one-fifth to four-fifths of the radius of the top cover 31, preferably two-fifths to four-fifths, for example, the radius R is one-fifth, two-fifths, three-fifths, four-fifths of the radius of the top cover 31. In this way, the first air blowers 32 can deflate and inflate the inflatable doll 100 efficiency.

The top cover 314 defines the first air outlet portion 312. In one embodiment, the first air outlet portion 312 is a through hole, specifically, the through hole is defined along a circumferential direction of the top cover 314 and corresponds to the second air outlet portions 322, the air can flow into the body 10 through the first air outlet portion 312 smoothly, and the through hole does not need to pass through the top cover 314 completely in the circumferential direction to divide the top cover 314 into two independent parts. In another embodiment, the first air outlet portion 312 includes a plurality of through holes arranged at intervals, and each through hole corresponds to one corresponding second air outlet portion 322. In a further embodiment, the first air outlet portion 312 includes a plurality of mesh structures, each mesh structure defines at least one through hole, and each mesh structure corresponds to one corresponding second air outlet portion 322.

In one embodiment, the central area of the top cover 314 includes a mounting portion 3141, the first air outlet portion 312 surrounds the mounting portion 3141. When the first air outlet portion 312 includes through holes or mesh structures 3140, the through holes and the mesh structures 3140 are arranged around the mounting portion 3141, and each two adjacent through holes or each two adjacent mesh structures 3140 are separated by a connecting rib 3142, and the connecting rib 3142 is connected between the mounting portion 3141 and an edge of the top cover 314 to increase the strength of the top cover 314. The second air outlet portion 322 is received in the through hole or partially extended out of the through hole, or the second air outlet portion 322 is connected with the mesh structure 3140. The second air outlet portion 322 and the flange 3221 are flush with the outer surface of the top cover 314 or protruded out of the outer surface of the top cover 314. The top cover 314 and the mounting portion 3141 may be circular, and the through hole or the mesh structure 3140 may be fan-shaped. At this time, the second air outlet portion 322 may be fan-shaped and arranged concentrically, and the first air outlet portions 321 may also be are fan-shaped and arranged concentrically. It should be understood that the shapes of the top cover 314, the mounting portion 3141, the through hole and the mesh structure 3140 can be set according to actual needs.

The outer surface of the top cover 314 or the side wall 313 defines a groove 3143 which is defined along the circumference of the top cover 314 or the side wall 313. The body 10 defines a through hole 101. Specifically, the through hole 101 is defined in the bottom of the body 10 and communicated with the cavity 11. An edge of the through hole 101 crimps to form a receiving portion 102, and the receiving portion 102 defines a via hole 103. The receiving portion 102 can sleeve on the top cover 314 or the side wall 313 and fixed in the groove 3143 by a connecting element 104. A connecting element 104 can pass through the receiving portion 102 through the via hole 103, and securely fix the receiving portion 102 in the groove 3143. The connecting element 104 includes a connecting strip 1041, a fixing portion 1043 connected with the first end 1042 of the connecting strip 1041, the connecting strip 1041 is accommodated in the receiving portion 102 and surrounds around the bottom wall of the groove 3143, the second end 1044 of the connecting strip 1041 is inserted into a through hole 1045 of the fixing part 1043, to fix the receiving part 102 in the groove 3143.

The accessory 30 further includes a sound system 34 (which may be a stereo, a speaker, a loudspeaker, or the like) and a first sound collecting member 351 (which may be a microphone, a sound pick-up, or the like) electrically connected with the main controller 33. The sound system 34 is mounted on the mounting portion 3141, and the present disclosure does not limit the method for mounting the sound system 34 on the mounting portion 3141, the sound system 34 can be detachably or fixedly mounted on the mounting portion 3141, the sound system 34 can also glued on the mounting portion 3141. The first sound collecting member 351 is configured to collect the sound emitted from the sound system 34 and transmit a sound signal to the main controller 33, and the main controller 33 controls the operation of at least one first air blower 32 of the first air blowers 32 according to the sound signal. Specifically, the sound system 34 can play a variety of music with different rhythms, the first sound collecting member 351 collects the sound continuously or intermittently and transmits the sound signals to the main controller 33 continuously or intermittently, and the main controller 33 controls the operation of at least one first air blower 32 in the first air blowers 32 according to the rhythm information in the sound signals, such that the inflatable doll 100 can perform actions according to the rhythms of the music and move rhythmically.

The first sound collecting member 351 can also collect human voice and send the voice signal to the main controller 33. It should be understood that, the first sound collecting member 351 can also collect voices of robots or voices of other animals such as parrots, and send voice signals to the main controller 33. The accessory 30 further includes a first speech recognizing server 352, a chip 353, and a second speech recognizing server 354. The first speech recognizing server 352 is electrically connected with the main controller 33, and configured for recognizing the speech signal processed by the main controller 33 and sending a recognition result to the main controller 33. The chip 353 is electrically connected with the main controller 33 and pre-stores vocabularies, and configured for sending a first feedback containing text information to the main controller 33 according to the vocabularies and recognition result. The second speech recognizing server 354 is electrically connected with the main controller 33 and configured for sending a second feedback containing a sound signal to the sound system 34, such that the accessory 30 can communicate with the user. The main controller 33 can send instructions to the first air blower 32 and/or sound system 34 according to the voice signal to control the operation of the first air blower 32 and/or sound system 34.

Specifically, the main controller 33 processes the voice signal, and sends the processed voice signal to the first speech recognizing server 352, and the first speech recognizing server 352 recognizes the processed voice signal and sends the recognition result to the main controller 33. The main controller 33 sends the recognition result to the chip 353, and then the chip 353 sends the first feedback containing text information to the main controller 33 according to the vocabularies and the recognition result. The main controller 33 sends the first feedback to the second speech recognizing server 354, and the second speech recognizing server 354 sends the second feedback containing the sound signal to the sound system 34, so as to communicate with the user.

The accessory 30 further includes a sensor 36 for sensing whether someone enters into a sensing area of the sensor 36. The sensor 36 sends a sensing signal to the main controller 33 when sensing that someone enters into the sensing area, and the main controller 33 controls the sound system 34 to play voice information according to the received sensing signal. In this way, the inflatable doll 100 can communicate with the user, or the user can be guided to communicate with the inflatable doll 100. The voice information includes greeting, self-introduction, music, news, etc.

When the user in the sensing area tells the inflatable doll 100 that he wants the inflatable doll 100 to tell a story, the main controller 33 controls the sound system 34 to tell the story according to the communication with the user. After receiving the sensing signal, the main controller 33 can also control the operation of at least one first air blower 32 of the first air blowers 32 according to the communication with the user. For example, when the user in the sensing area tells the inflatable doll 100 that he wants the inflatable doll 100 to dance, the main controller 33 controls the operations of the first air blowers 32 according to the communication with the user, such that the inflatable doll 100 can dance.

The inflatable doll 100 can also act on its own initiative, such as greeting automatically. When sensing that someone enters into the sensing area, the sensor 36 sends the sensing signal to the main controller 33, and the main controller 33 controls the operation of at least one first air blower 32 of the first air blowers 32 according to the received sensing signal. Specifically, when sensing that someone enters into the sensing area, the sensor 36 sends the sensing signal to the main controller 33, and the main controller 33 controls the front first air blower to stop working according to the received sensing signal, the air in the front portion of the body 10 flows out, and the front portion of the body 10 deforms, such that the inflatable doll 100 bows to pay respect; or the main controller 33 controls the left first air blower 32 to stop working, after the inflatable doll 100 bends to the left, the left first air blower 32 is controlled to start working, the inflatable doll 100 stands upright again, then the right first air blower 32 is controlled to stop working, after the inflatable doll 100 bends to the right, the right first air blower 32 is controlled to start working, and the inflatable doll 100 stands upright again; repeatedly, the inflatable doll 100 swings to attract customers.

The accessory further includes a lamp 37 arranged on the sound system 34. The lamp 37 may be a LED lamp, an atmosphere lamp, a fluorescent lamp, or an electrodeless lamp. The lamp 37 is arranged on the sound system 34 and located at the top portion of the accessory 30 to avoid an interference of the other components of the accessory 30 to the lamp 37. The lamp 37 includes at least one illuminating part 371, a lampshade 372 covered on the at least one illuminating part 371, a secondary controller 373 configured to control the at least one illuminating part 371, a second sound collecting member 374 (which may be a microphone, a sound pick-up, or the like), and a lamp housing 375, the lamp housing 375 is configured to accommodate the at least one illuminating part 371, the lampshade 372, the secondary controller 373 and the second sound collecting member 374. The secondary controller 373 is electrically connected with the main controller 33 and the power plug 39. The main controller 33 can send instructions to the lamp 37 to control the operation of the lamp 37 according to the communication with the user. In one embodiment, when user tells the inflatable doll 100 to turn on the lamp 37, the main controller 37 turns on the lamp 37 by the secondary controller 373. The sound system 34 includes an outer housing 341 and a speaker unit (not shown) accommodated in the outer housing 341, and the outer housing 341 is detachably or fixedly mounted on the mounting portion 3141. The lamp housing 375 is arranged on the outer housing 341. The outer housing 341 defines a first via hole, and the mounting portion 3141 also defines a second via hole, and wires of the sensor 36 and the first sound collecting member 351 can pass through the first via hole (not shown) and the second via hole (not labeled) to electrically connect with the main controller 33. The body 10 of the inflatable doll 100 defines two mounting holes 1001, and the sensor 36 and the first sound collecting member 351 are respectively mounted in the mounting holes 1001 and exposed from the inflatable doll 100.

Each illuminating part 371 can emit white light, colored light, flashing light, etc. Different illuminating parts 371 can emit light of different colors or light of different types. Preferably, the lamp 37 is an atmosphere lamp. An ambient light is formed after the light emitted by the illuminating part 371 passing through the transparent or translucent lampshade 372, the ambient light can render the atmosphere in the body 10. The lampshade 372 can be replaced to acquire different lighting effects, such as starry sky lighting effect, flame lighting effect, animal lighting effect, etc.

The second sound collecting member 374 is disposed adjacent to the sound system 34, in this way the sound collected by the second sound collecting member 374 is accurate. Even when the inflatable doll 100 is in a noisy environment, the second sound collecting member 374 can still collect accurate sound signal from the sound system 34. In detail, the second sound collecting member 374 is received in the lamp housing 375 and adjacent to the sound system 34. The second sound collecting member 374 collects the sound from the sound system 34 and transmits the sound signal to the secondary controller 373, and the secondary controller 373 controls the operation of the at least one illuminating part 371 according to the sound signal. In one embodiment, the secondary controller 373 can turn on or off the lamp 37 according to the sound signal, can control at least one of the illuminating parts 371 to work independently according to the sound signal, and can also control at least two of the illuminating parts 371 to work independently or simultaneously according to the sound signal. In another embodiment, the secondary controller 373 can control the number of the illuminating part 371 in operation according to the sound signal, and control the intensity and lighting time of the light emitted from the illuminating part 371. So that the lighting effect can follow the rhythm of the sound from the sound system 34. Specifically, when the sound stops, the illuminating part 371 stops working; when the sound gets stronger gradually, the light intensity of the light emitted from the illuminating part 371 also gets stronger gradually, or the number of the illuminating part 371 in operation increases gradually; when the rhythm of the sound changes, the illuminating parts 371 which can emit different coloured light are turned on alternately, or the type of the light emitted from the illuminating parts 371 changes accordingly. So that, the light effect matches with the rhythm of the sound.

The lamp housing 375 includes a support housing 3751 for supporting the lampshade 372, and a base 3752. The base 3752 is disposed on the outer housing 341 of the sound system 34. An end of the support housing 3751 has a step 3753 for supporting the secondary controller 373. The illuminating part 371 is disposed on an upper surface of the secondary controller 373. The second sound collecting member 374 is arranged on a lower surface of the secondary controller 373, or arranged on the support housing 3751 or the base 3752. So that, the second sound collecting member 374 is arranged adjacent to the sound system 34.

The driving member 376 is arranged below the secondary controller 373, and the driving member 376 is a motor or the like. The driving member 376 is arranged in the support housing 3751 and supported by the base 3752, or arranged at the lower surface of the secondary controller 373. In one embodiment, the driving member 376 includes an upper housing 3761, a lower housing 3762, an output shaft 3763 and a gear set 3764, the driving member 376 is connected to the secondary controller 373 by the upper housing 3761 which is connected with the lower surface of the secondary controller 373. The gear set 3764 is arranged in the upper housing 3761 or the lower housing 3762. The center portion of the secondary controller 373 defines a through hole 3731, the illuminating parts 371 surround the through hole 3731, and a connecting rod 378 passes through the through hole 3731 and connects with the lampshade 372. In one embodiment, the gear set 3764 includes a first gear 3771 (the first gear 3771 can also be a connecting element which does not have the teeth and connects the connecting rod 378 with the output shaft 3763) sleeved on the output shaft 3763, the first gear 3771 connects the connecting rod 378 with the output shaft 3763, the driving member 376 can rotate the connecting rod 378 and the lampshade 372 to improve the light effect; in another embodiment, the gecith the third gear 3773, in this way, the driving member 376 can rotate the connecting rod 378 and the lampshade 372, to improve the lighting effect. At least one of the first gear 3771, the second gear 3772 and the third gear 3773 is supported by a support rod (not labeled) or a fourth gear 3774 and has a certain height, to facilitate transmission of force.

At least one accommodating portion 3754 is defined on the upper surface or the lower surface of the base 3752, and at least one battery (not shown) is accommodated in the accommodating portion 3754 to supply power to the driving member 376. The battery may be a disposable battery or a rechargeable battery. When the battery is the rechargeable battery, the battery can be connected with the main controller 33, and connected with an external power source by the main controller 33 and the power plug 39.

The accessory 30 further includes a wireless connecting module 38 electrically connected with the main controller 33, the wireless connecting module 38 is wirelessly connected to the mobile device of the user and configured to transmit the instructions of the user by APP in the mobile device to the main controller 33.

The inflatable doll 100 further includes at least one expandable member 14 and at least one second air blower 15 electrically connected with the main controller 33, the controller 33 can adjust deflation times and deflation frequencies of the first air blower 32 and the second air blower 15, for bringing the body 10 to move dynamically. The at least one second air blower 15 is arranged on the at least one expandable member 14 for directing the air in the at least one expandable member 14 into the cavity 11. The expandable member 14 is connected with the main part 12 and/or the secondary part 13 by means of sewing or gluing. The expandable member 14 is expandable, flexible or deformable, and capable of expanding or contracting under an action of the second air blower 15. The expandable member 14 defines a through hole 141 communicated with the cavity 11, the air in the body 10 can flow into the expandable member 14 automatically to inflate the expandable member 14. Under the action of the second air blower 15, the expandable member 14 deflates and deforms to move the main part 12 and/or the secondary part 13.

The second air blowers 15 may be bi-direction, and the main controller 33 can control the second air blowers 15 to direct air into their respective expandable members 14, and can also control the second air blowers 15 to direct air out of their respective expandable members 14. In this way, the inflatable doll 100 can act dynamically in a faster way.

The expandable member 14 is made of flexible material which can be inflated to expand and erect to a prearranged configuration and can also be deflated to perform different attractive actions. In detail, the body 10 is made of air-tight cloth, air-tight fabric, rubber, polyphthalamide, thermoplastic urethanes (TPU), polyphenylenesulfide-based fiber (PPS), polyetheretherketone-based fiber (PEEK), nylon, and the like wholly aromatic polyamide fiber, wholly aromatic polyester fiber, polyimide-based fiber, polyetherimide-based fiber, vinylon-based fiber, acrylic-based fiber, cellulose-based fiber, silicon carbide-based fiber, alumina-based fiber, glass-based fiber, carbon-based fiber, steel-based fiber, and the like. The expandable member 14 may also be transparent or translucent.

The first air blower 32 and the second air blower 15 are intermittently actuated air blowers. An air drafting capability of the second air blower 15 is lower in pressure than that of the first air blower 32. The first air blower 32 has a power of about 5-300 W, preferably 110-300 W; and the second air blower 15 has a power of about 5-100 W, preferably 20-50 W. The power of each of the first air blower 32 and the second air blower 15 may be set according to actual needs, so as to adjust the deflation rate of the body 10 and the expandable member 14, further to adjust a deformation rate of the primary part 11 and/or the secondary part 13.

The first air blower 32 directs the air into the body 10 to inflate the body 10 and the expandable member 14 and move the body 10. The second air blower 15 discharges the air from the expandable member 14, the expandable member 14 deforms to move the body 10. The air in the body 10 flows back into the expandable member 14, the expandable member 14 expands and deforms to move the body 10 again. It should be understood that the expandable member 14 can be arranged in different portions of the body 10 as required, for example, the expandable members 14 are arranged in the hand, arm, mouth, hat, leg of the ghost doll. Each expandable member 14 can deform independently, allowing different portions of the inflatable doll 100 to move independently and precisely.

The second air blower 15 can work intermittently, and deflate the main part 12 and/or the secondary part 13 intermittently to move the main part 12 and/or the secondary part 13. Under the action of the second air blower 15, the expandable member 14 may be deflated two to eight times per minute

The second air blower 15 is disposed in the expandable member 14 and faces towards the outside of the expandable member 14, and a third air outlet portion 151 of the second air blower 15 faces towards the outside of the expandable member 14. Thus, air within the expandable member 14 can be directed out of the expandable member 14 to move the primary part 12 and/or the secondary part 13. In one embodiment, the third air outlet portions 151 of the second air blowers 15 may face towards the same direction or different directions.

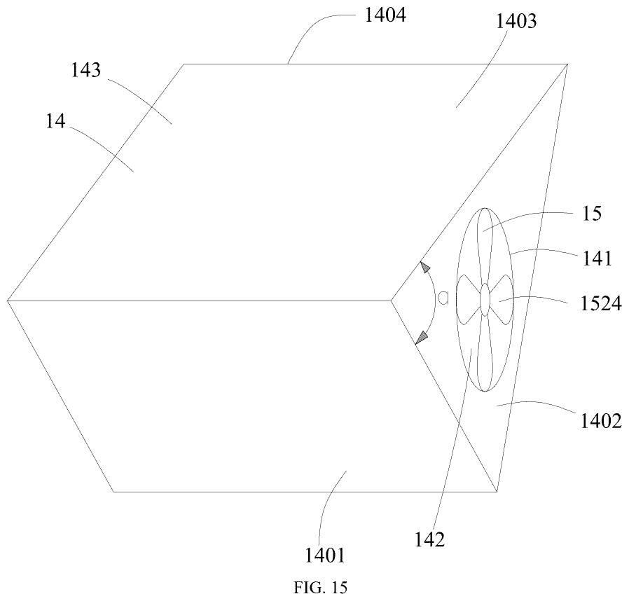

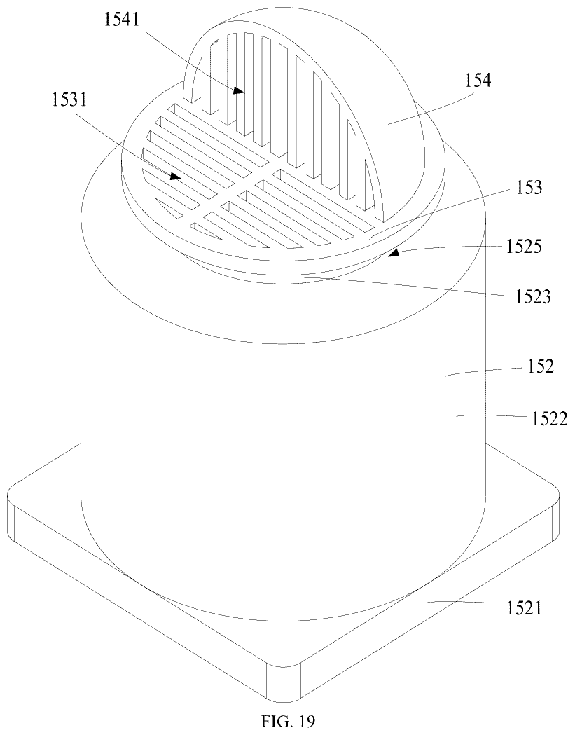

The expandable member 14 includes an inner side 142 and an outer side 143. The through hole 141 passes through the inner side 142 and the outer side 143. The second air blower 15 can be a simple fan as shown in FIGS. 15-18. In another embodiment, the second air blower 15 has a complicate structure as shown in FIGS. 19-21, the second air blower 15 further includes a protective housing 152, a third air inlet portion 153 and a fourth air inlet portion 154, the third air inlet portion 153 and the fourth air inlet portion 154 are both protruded from the protective housing 152 and received in the expandable member 14, the third air outlet portion 151 is also protruded from the protective housing 152, and the third air outlet portion 151 is arranged outside the expandable member 14. The third air inlet portion 153 is connected with the fourth air inlet portion 154. Preferably, the third air inlet portion 153 is perpendicular to the fourth air inlet portion 154. The protective housing 152 includes a support wall 1521 arranged outside the expandable member 14, a cylindrical body 1522 connected with the support wall 1521 and arranged outside the expandable member 14, and a connecting portion 1523 connected between the cylindrical body 1522 and the third air inlet portion 153 and arranged in the expandable member 14. A fan 1524 (also referred to as an impeller) is arranged in the cylindrical body 1522 and configured to direct the air in the expandable member 14 out.

The third air inlet portion 153 extends from the connecting portion 1523 of the protective housing 152 along a first direction, the first direction is parallel with an axis direction of the protective housing 152. The third air outlet portion 151 extends from the support wall 1521 of the protective housing 152 along a second direction. The third air inlet portion 153 has a round shape, and a diameter of the third air inlet portion 153 is greater than that of the connecting portion 1523, and a diameter of the cylindrical body 1522 is also greater than that of the connecting portion 1523, such that the third air inlet portion 153, the connecting portion 1523 and the cylindrical body 1522 cooperatively form a fixing portion 1525 which may be a fixing groove. The second direction is perpendicular to the first direction. The fourth air inlet portion 154 has a semicircle shape and extends from the third air inlet portion 153 along the first direction. The third air inlet portion 153 defines at least one first inlet 1531, the fourth air inlet portion 154 defines at least one second inlet 1541, the third air outlet portion 151 defines at least one outlet 1511 communicated with the first inlet 1531 and the second inlet 1541. The air in the expandable member 14 is directed out through the first inlet 1531, the second inlet 1541 and the outlet 1511, and the air in the body 10 can flow into the expandable member 14 through the outlet 1511, the first inlet 1531 and the second inlet 1541. In one embodiment, an extension direction of the first inlet 1531 is perpendicular to the first direction, an extension direction of the second inlet 1541 is parallel with the first direction, and an extension direction of the outlet 1511 is also perpendicular to the first direction.

An edge of the through hole 141 is connected with the second air blower 15 by another connecting element 104. The edge of the through hole 141 crimps to form a receiving portion 1411, and the receiving portion 1411 defines a through hole 1412, and the second air blower 15 is partially accommodated in the expandable member 14. Specifically, both the third air inlet part 153 and the fourth air inlet part 154 are accommodated in the expandable member 14, the third air outlet part 151 is arranged outside the expandable member 14, the receiving portion 1411 is arranged around the fixed portion 1525, and the connecting element 104 connects the second air blower 15 with the expandable member 14. When the body 10 and the expandable member 14 are inflated, since the expandable member 14 is connected with the body 10, the expandable member 14 can fix or support the second air blower 15.

Specifically, there are at least two expandable members 14 arranged in the main part 12 and adjacent to each other at a same height, the second air blowers 15 corresponding to the at least two expandable members 14 in the main part 12 are arranged towards the same direction or towards different directions; there are at least two expandable members 14 arranged in the secondary part 13 and adjacent to each other at a same height, the second air blowers 15 corresponding to the at least two expandable members 14 in the secondary part 13 are arranged towards the same direction or towards different directions; there are two expandable members 14 respectively arranged in two secondary parts 13 and adjacent to each other at a same height, the second air blowers 15 corresponding to the two expandable members 14 in the two secondary parts 13 are arranged towards the same direction or arranged towards different directions.

Referring to FIG. 15, the expandable member 14 in the inflated state has a substantially triangular prism shape, which includes a bottom surface 1401, two opposite triangular surfaces 1402 respectively connected with two sides of the bottom surface 1401, and two parallelogram surfaces 1403 connected with the bottom surface 1401 and the triangular surface 1402. An area of a cross section of the expandable member 14 gradually decreases in a direction from the bottom surface 1401 to the connecting edge 1404. When the expandable member 14 is inflated, an angle α formed by the bottom surface 1401 and the parallelogram surface 1403 is about 30-60°. For example, the angle α is 30°, 40°, 50°, or 60°. The second air blower 15 is arranged on the bottom surface 1401, the triangular surfaces 1402 or the parallelogram surface 1403. In one embodiment, at least one of the bottom surface 1401, the triangular surface 1402, and the parallelogram surface 1403 is a flat surface or a curved surface. The second air blower 15 which has a simple structure or the complicate structure is mounted on the surface of the expandable member 14 that is not sewed or glued with the body 10.

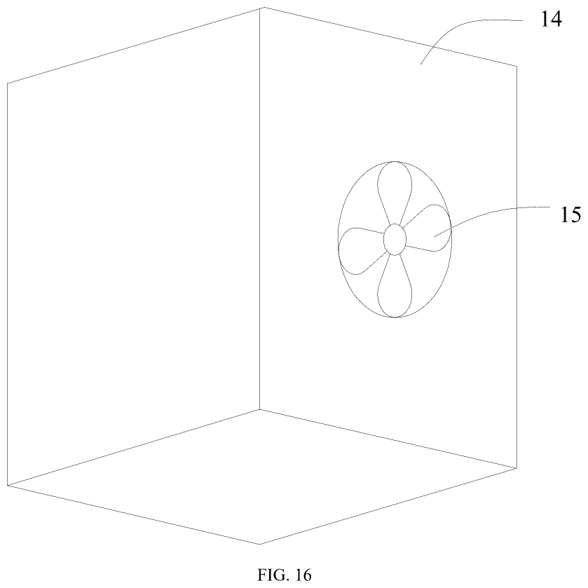

Referring to FIGS. 16-18, the expandable member 14 has a substantially hexahedral shape, a cube shape, a parallelepiped shape, or an irregular hexahedral shape. At least one surface 1405 of the expandable member 14 is a flat surface or a curved surface.

The expandable member 14 has an irregular shape and includes a first expandable portion 144, a second expandable portion 145 and a connecting portion 146, and the first expandable portion 144 is communicated with the second expandable portion 145 by the connecting portion 146. The cross section of the first expandable portion 144 or the second expandable portion 145 is substantially trapezoidal shaped. The cross-section of the connecting portion 146 is substantially circular, square or irregular shaped. The connecting portion 146 is rigid and and cannot deform, or the connecting portion 146 is flexible, expandable and deformable.

The area of the cross-section of the first expandable portion 144 is one to three times that of the connecting portion 146, or the area of the cross-section of the second expandable portion 145 is one to three times that of the connecting portion 146, to form a notch 147 between the first expandable portion 144 and the second expandable portion 146. The first expandable portion 144 and the second expandable portion 145 can deform into the notch 147, such that the body 10 can deform faster and move downwards for a much more distance in a shorter time.

The first expandable portion 144 includes a first surface 1441 opposite to the connecting portion 146, the second expandable portion 145 includes a second surface 1451 opposite to the connecting portion 146, the first surface 1441 is parallel to the second surface 1451, and the first surface 1441 and second surface 1451 incline in the same direction, to increase a size of notch 147.

The first surface 1441 or the second surface 1451 defines a through hole 1442 for mounting the second air blower 15. The first surface 1441 is arranged towards the accessory 30, and the second surface 1451 is arranged opposite to the accessory 30.

A third surface 1443 of the first expandable portion 144 and a fourth surface 1453 of the second expandable portion 145 both define a through hole 1444 communicated with the connecting portion 146.

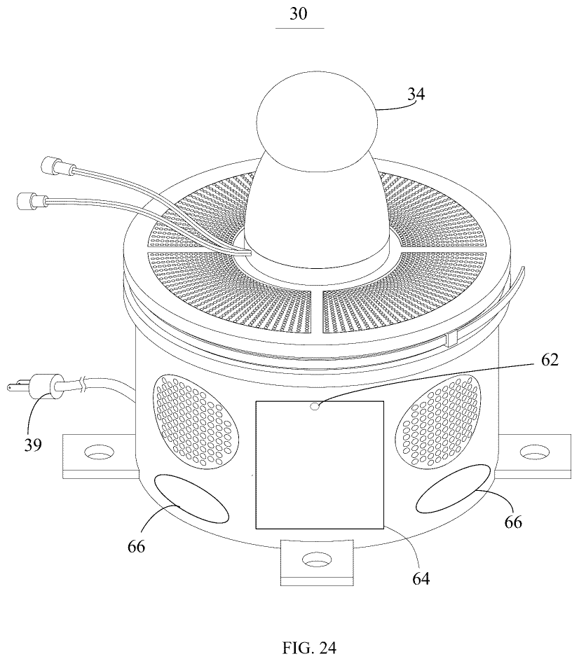

Referring to FIGS. 1, 2, 3, 6, 23 and 24, the inflatable doll 100 further includes an AI assembly 60 which can process various types of data such as text, image, audio, and video. The AI assembly 60 encodes multi-modal inputs into vectors through the Transformer architecture and then achieves cross-modal understanding through the self-attention mechanism. The inflatable doll 100 can provide education, entertainment, games, emotional interaction, intelligent companionship, etc.

The AI assembly 60 includes an AI chip 61. The AI chip 61 may be a Qualcomm QCS610 AI chip, a Qualcomm QCS6490 chip, or the like. The AI chip 61 supports the Android system, IOS system, Hongmeng system, and the like, and equipped with an AI accelerator (Hexagon DSP). The AI chip 61 is capable of running Gemini models especially lightweight Gemini models locally.

The AI chip 61 can be connected with an APP on the electronic device 201 by the wireless communication module 38. Users can control the AI assembly 60 via the APP, thereby controlling the operations of the inflatable toy 100. The wireless communication module 38 can also electrically connect the AI chip 61 to Gemini cloud and return AI results to the AI chip 61. In one embodiment, the APP can call Gemini Nano to process data or signals from the AI chip 61 and sends results to the AI chip 61, and the AI chip 61 can control the modules to operate accordingly. In another embodiment, the AI chip 61 can run Gemini Nano, and the AI chip 61 can directly process the data or signals and control the modules to operate accordingly; at this time, the AI chip 61 can communicate with users without being connected to the Internet.

The AI assembly 60 further includes at least one camera 62, at least one audio module 63, at least one display screen 64, and a battery 65. The at least one camera 62, the at least one audio module 63, the at least one display screen 64, and the battery 65 are all electrically connected with the AI chip 61. The AI chip 61 is configured to process data transmitted from the above modules, such as the camera 62, the audio module 63, the display screen 64, the battery 65, the sound system 34, the sensor 36, the lamp 37, the power plug 39, the first air blower 32, and the second air blower 15, and so on. After AI algorithm reasoning, the AI chip 61 transmits instructions or feedback signals to the corresponding modules to enable them to perform corresponding operations. It should be understood that, the AI chip 61 can control the sound system 34, the sensor 36, the lamp 37, the power plug 39, the first air blower 32, and the second air blower 15 through the main controller 33.

The camera 62 is configured to capture images or videos of the surrounding environment, and data acquired by the camera 62 can be transmitted to the AI chip 61. The AI chip 61 can process image or video signals for various applications, such as human shape detection, expression detection, facial recognition, gesture recognition, gesture tracking, and so on. The camera 62 can be equipped with a CMOS (Complementary Metal Oxide Semiconductor) sensor that supports autofocus and an infrared cut-off filter that ensures accurate color.

In one embodiment, two cameras 62 are positioned at the two eye positions, respectively. In another embodiment, the camera 62 can be arranged at the housing 31. In a further embodiment, the camera 62 is integral with the display screen 64 and arranged on the display screen 64. It should be understood that the number and the position of the camera 62 can be arranged according to the actual needs.

The audio module 63 includes the microphone 351 and the speaker 34. The microphone 351 is preferably a microphone array, such as a 4-channel digital microphone, which supports beamforming and noise reduction. The speaker 34 supports TTS voice announcements and can play audio generated by Gemini. The audio module 63 supports voice command recognition through integrated NLP algorithms and can simulate conversational responses using text-to-speech synthesis with adjustable pitch/timbre parameters. In one embodiment, the mouth position of the inflatable doll 100 is provided with one speaker.

In one embodiment, the display screen 64 can be arranged on the housing 31. In another embodiment, the body 10 is arranged with one display screen 64. User can operate the inflatable doll 100 through the display screen 64. The display screen 64 may utilize OLED or LCD technology with capacitive touch capabilities, supporting multi-touch gestures and adaptive brightness adjustment via ambient light sensors. The screen's resolution ranges from 720p to 4K depending on model configuration, with anti-glare coating for improved visibility under various lighting conditions.

In one scenario, the camera 62 captures an individual, such as a child, and subsequently transmits the captured image signal to the AI chip 61. The AI chip 61 then verifies whether the subject's facial recognition parameters meet established criteria. Upon affirmative determination, the inflatable doll 100 initiates activation.

In one scenario, the camera 62 captures a person such as a child, then sends an image signal to the AI chip 61. The AI chip 61 forwards the image signal to Gemini which processes it and feeds back a signal of detecting a child to the APP. The camera 62 can also monitor the child's facial expressions in real time and send these signals to Gemini, Gemini analyzes the signals and identifies the emotion of the child, Gemini generates comforting dialogue to AI chip 61 if the child is sad. And the AI chip 61 can also control the speaker 34 to play soothing music or adjust the lamp 37 to a comforting mode, thereby enhancing the companionship of the inflatable doll 100.

In one scenario, the camera 62 captures an individual, such as a child, and subsequently transmits the captured gesture signal to the AI chip 61. The AI chip 61 processes it and feeds back an operation signal to control the corresponding module to operate. For example, the child makes the gesture of waving his hand, the camera 62 captures the gesture signal and transmits the captured gesture signal to the AI chip 61, the AI chip 61 processes it and feeds back an operation signal to the first air blowers 32 and/or the second air blower 15, the first air blowers 32 and/or the second air blower 15 move the hands of the inflatable doll 100. It should be understood that, the camera 62 captures the gesture of the child in real time.

In one scenario, the microphone 351 receives user's question voice, and transmits a signal to the AI chip 61. The AI chip 61 transmits the signal to Gemini which subsequently generates an answer signal to the AI chip 61, then the speaker 34 plays the answer. Or the AI chip 61 generates an answer signal independently and controls the speaker 34 to play the answer.

In one scenario, the microphone 351 receives user's operation voice, and transmits a signal to the AI chip 61. The AI chip 61 transmits the signal to Gemini which generates an operation signal to the AI chip 61, then the AI chip 61 controls the corresponding module to operate. Or the AI chip 61 generates an operation signal independently and controls the corresponding module to operate. For example, user said to the inflatable doll 100, “start working”, the microphone 351 sends the signal to the AI chip 61, the AI chip 61 controls the first air blowers 32 and/or the second air blower 15 to work. For another example, user said to the inflatable 100, “how to grow taller”, the AI chip 61 transmits the signal to Gemini, Gemini generates an answer signal to the AI chip 61, and the AI chip 61 controls the speaker 34 plays the answer.

For another example, user said to the inflatable doll, “play cartoons on the display screen 64”, the microphone 351 sends the signal to the AI chip 61, the AI chip 61 transmits the signal to Gemini, Gemini then accesses the cloud-based media library or local storage to retrieve age-appropriate animated content, the AI chip 61 decodes the video stream using H.265/HEVC compression protocols while applying real-time subtitles through integrated speech-to-text conversion. In this way, the display screen 64 can play the cartoons according to the instructions.

The battery 65 is arranged in the housing 31 and can be used to provide power to the AI assembly 60. Preferably, the battery 65 is a rechargeable battery. When the power plug 39 is electrically connected with the external power, the battery 65 can be charged. In another embodiment, the AI assembly 60 further includes at least one solar panel 66 which can be arranged on the housing 31, the solar panel 66 can be used to supply power to the battery 65.

In one embodiment, the main controller 33 and the chip 353 can be integrally formed with the AI chip 61, enabling direct coordination for some management functions such as monitoring battery charging status, optimizing energy distribution, and the AI chip 61 pre-stores vocabularies, knowledge graph database (such as common sense, encyclopedia, fun questions and answers, or the like), cartoons, TV series, etc. Video information and text information on the Internet can also be stored in the AI chip 61 through the wireless communication module. The AI chip 61 can process the signals to outputs feedback signals to the modules according to the pre-stored information and the recognition result. This integrated configuration enhances overall system reliability. The AI assembly 60 can further include the first speech recognizing server 352 and the second speech recognizing server 354, and the AI assembly 60 can communicate with user intelligently.

In another embodiment, the chip 353 can be integrally formed with the AI chip 61 and electrically connected with the main controller 31, and the AI chip 61 pre-stores vocabularies and can process the signals to outputs feedback signals to the to the main controller 31 according to the vocabularies and the recognition result. The AI assembly 60 can further include the first speech recognizing server 352 and the second speech recognizing server 354, and the AI assembly 60 can communicate with user intelligently.

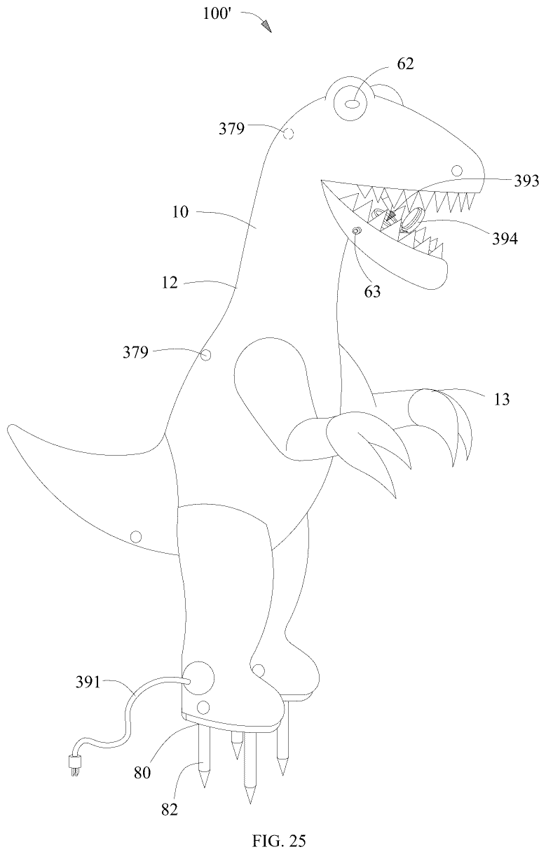

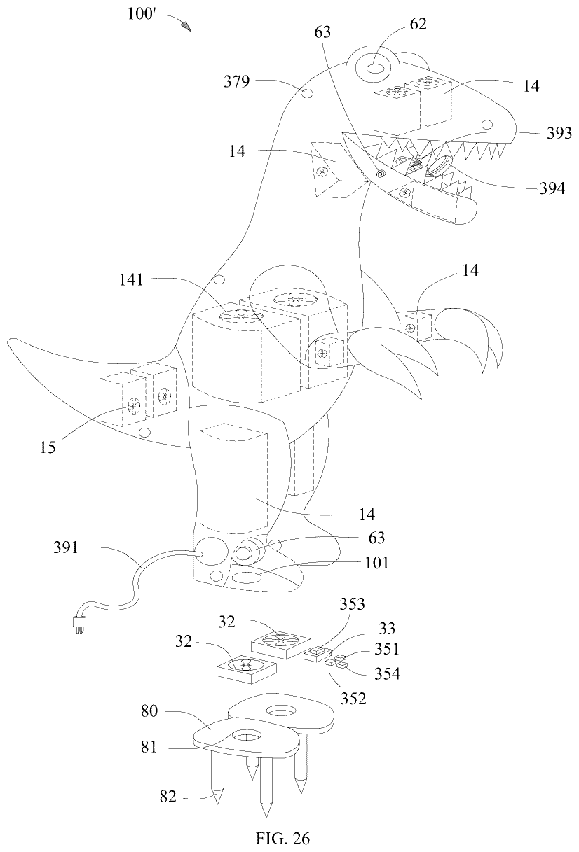

Referring to FIGS. 25 and 26, the present disclosure further provides an inflatable doll 100′ according to a second embodiment. The inflatable doll 100′ and the inflatable doll 100 have the similar structure, and the differences between the two dolls at least include: the inflatable doll 100′ has a configuration of dinosaur; the body 10 is provided with a plurality of lamps 379 electrically connected with the AI chip 61 or the main controller 33, the lamp 379 may be a LED lamp which can emit white light or color light.

The eye position of the inflatable doll 100′ can also be provided with the camera 62 to monitor the surrounding visual environment. In one embodiment, each eye position is provided with one camera 62, and the mouth position of the inflatable doll 100′ can also be provided with one audio module 63 to simulate authentic speech, and the foot position is also provided with another audio module 63. The size and position of the audio module 63 can be adjusted according to the actual needs. It should be understood that, the audio module 63 can play songs, stories, sounds of dinosaurs, etc., for attracting the customers.

The positions of the expandable members 14 in the inflatable doll 100′ can be arranged according to the actual needs. For example, at least two expandable members 14 are arranged in the main part 12 and adjacent to each other at a same height, at least two expandable members 14 are arranged in the secondary part 13 and adjacent to each other at a same height. The shapes of the expandable members 14 in the inflatable doll 100′ can also be arranged according to the actual needs. For example, the expandable member 14 in the inflated state can be arranged to have a substantially triangular prism shape, a substantially hexahedral shape, a cube shape, a parallelepiped shape, or an irregular hexahedral shape as described above. Each expandable member 14 defines at least one through hole 141, and the second air blower 15 can be arranged in the through hole 14 to direct air out of the expandable member 14 or blow air into the expandable member 14, so as to move the inflatable doll 100′ dynamically.

The inflatable doll 100′ further includes a base 80 connected with the body 10 and configured to fix the inflatable doll 100′. The base 80 defines an air inlet 81 communicated with the through hole 101, the first air blower 32 is adjacent to the through hole 101 and the air inlet 81 to blow air into the inflatable doll 100′. The base 80 further includes at least one foot 82 arranged on a bottom surface of the base 80, the foot 82 can extend into the ground to fix the inflatable doll 100′. In at least one embodiment, the base 80 includes a plurality of feet 82 spaced apart from each other. It should be understood that, the shape and the inner structure of the first air blower 32 can be designed according to actual needs.

The microphone 351, the first speech recognizing server 352, the chip 353, and the second speech recognizing server 354 all received in the body 10. Specifically, the microphone 351, the first speech recognizing server 352, the chip 353, the second speech recognizing server 354, and the main controller 33 can be arranged on the base 80; the AI chip 61 can also be arranged on the base 80.

The inflatable doll 100′ further includes a power plug 391 arranged on the body 10. The power plug 391 is electrically connected with the main controller 33 and/or the AI chip 61, the power plug 391 may be connected with an external power supply and provides power to the first air blower 32, the second air blower 15, the AI assembly 60, and so on.

The inflatable doll 100′ further includes an air outlet 393, a sealing plug 394 is provided to open or airtightly seal the air outlet 393. In this way, air is prevented from leaking out of the inflatable doll 100′.

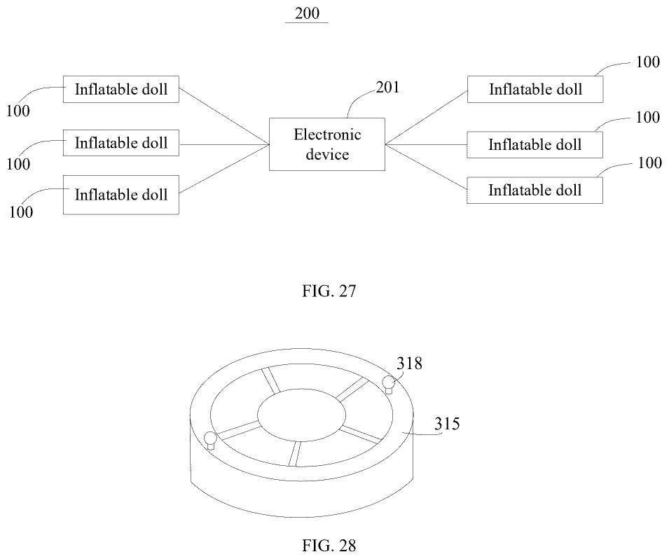

Referring to FIG. 27, the present disclosure further provides an inflatable doll set 200, which includes a plurality of inflatable dolls 100. The inflatable dolls 100 can communicate with each other through the AI assembly 60. The inflatable dolls 100 can be designed in different shapes. For example, the inflatable dolls 100 can be designed as cartoon character shapes.

In one scenario, several inflatable dolls 100 can be configured to play different roles which can interact with each other, such as perform role-playing according to a script or TV show. In a specific embodiment, four inflatable dolls are in front of the courtyard, surrounding the “Wishing Star Tree”; the inflatable doll named Max waves and nods, saying, “Wow! Guest is coming! Welcome to the Christmas Star Wishing Courtyard”, and the star hat of Max can also emit light for several times; Max then turns to the inflatable doll named Luna and says, “Luna, our first star wish visitor is here today”; the light wings on her back gradually light up, Luna opens her hands and says, “Hello, You can tell me the wish, and I will help you”; the guest says, “I hope my family is healthy and happy!” Luna says, “This is the best wish, Max, start the starlight energy quickly!”; Max's star hat lights up, Max raises its head and says, “I received the wish! Let's light up the star wishing tree”; the star-shaped LED on the top of the “Wishing Star Tree” lights up and rotates; the inflatable doll named Dr. Zhizhi Deer raised his hoof, the heart-shaped light on his chest flashes, and says, “Wait a minute! Wait a minute! You didn't ask the most important question: What is the speed of light of the stars?”; Max says, “Doctor, today is not an exam day!”; the inflatable doll named Gugu begins to dance and says, “Gugu, now it's Christmas story time! I have a legend of ‘stars falling into socks’ to tell you!”

In another specific embodiment, four inflatable dolls play a game in front of the courtyard according to the script.

In another specific embodiment, four inflatable dolls and two children play a game in front of the courtyard according to the script.

It should be understood that, the AI chip 61 pre-stores a plurality of scripts, stories, movies, etc. User can update the information in the AI chip 61 on the APP. When the AI chip assembly 60 recognizes the key words from the user, the AI chip 61 can control the inflatable dolls 100 to perform the corresponding operation.

The inflatable dolls 100 can provide corresponding music, dialogues, videos, etc. during different holidays, such as Christmas, Halloween, Thanksgiving, Easter, and Independence Day. The inflatable dolls 100 can also further perform or provide AI interactions, dynamic actions, storytelling, music playing, video playing, lighting effects, etc.

It should be understood that, a controller can be provided to control the operations of the inflatable dolls 100 in the inflatable doll set 200. Under the control of the controller, the inflatable dolls 100 can communicate with each other, communicate with user, move dynamically, play games according to the script or TV show, play music, play videos, tell stories, offer light shows, etc.

As shown in FIG. 28, in another embodiment, the bottom wall 315 of the inflatable doll can be arranged with at least one roller 318, the roller 318 is used to move the inflatable doll 100 conveniently.

The above description is merely some embodiments. It should be noted that for one with ordinary skills in the art, improvements can be made without departing from the concept of the present disclosure, but these improvements shall fall into the protection scope of the present disclosure.

What is claimed is:

1. An accessory, applied to an inflatable doll, comprising:
at least one first air blower, comprising a first air inlet portion and a first air outlet portion communicated with the first air inlet portion and the inflatable doll; and
an AI assembly, electrically connected to the first air blower and configured to control the at least one first air blower to inflate or deflate the inflatable doll.

2. The accessory according to claim 1, wherein the at least one first air blower comprises a plurality of first air blowers, and the AI assembly is configured to control the first air blowers to inflate or deflate different portions of the inflatable doll through a through hole defined in a bottom of the inflatable doll independently, so that the inflatable doll is capable of acting dynamically.

3. The accessory according to claim 2, wherein the first air blowers are arranged along a circumference of the housing and face towards different portions of the inflatable doll, to inflate or deflate different portions of the inflatable doll.

4. The accessory according to claim 3, wherein the accessory further comprises a housing configured to mount the first air blowers, the housing comprises:
a plurality of second air inlet portion communicated with the first air inlet portions; and
a plurality of second air outlet portion communicated with the first air outlet portions and the inflatable doll, the first air outlet portions and the second air outlet portions are arranged along the circumference of the housing to correspond to different portions of the inflatable doll.

5. The accessory according to claim 4, wherein the housing comprises a plurality of second air outlet portions, the first air outlet portions are fan-shaped and arranged concentrically, and the second air outlet portions are also fan-shaped and arranged concentrically.

6. The accessory according to claim 4, wherein the housing further comprises a top cover, the second air outlet portions are arranged along a circumference of the top cover, and the second air outlet portions correspond to their respective first air outlet portions.

7. The accessory according to claim 6, wherein each of the second air outlet portions defines at least one via hole, a total area of the at least one via hole is two-fifths to four-fifths of an area of the an upper surface of the top cover.

8. The accessory according to claim 4, wherein the first air blower comprises:
a first casing, defining the first air inlet portion and the first air outlet portion, the first casing is integral with the second air inlet portion or the second air outlet portion; and
a second casing, detachably connected with the first casing.

9. The accessory according to claim 1, wherein the first air inlet portion is substantially perpendicular to the first air outlet portion.

10. The accessory according to claim 1, wherein the AI assembly comprises:
an AI chip, electrically connected to the first air blower; and
at least one camera, electrically connected to the AI chip and configured to collect an image or a video of surrounding environment and transmit an image or video signal to the AI chip.

11. The accessory according to claim 10, wherein
the accessory further comprises a housing configured to mount the first air blower; and
the AI assembly further comprises at least one display screen electrically connected with the AI chip and arranged on the housing.

12. The accessory according to claim 11, wherein one of the at least one camera is integral with the display screen.

13. The accessory according to claim 10, wherein the AI assembly further comprises at least one display screen electrically connected with the AI chip, the display screen is arranged on the inflatable doll.

14. The accessory according to claim 10, wherein the AI chip pre-stores vocabularies, the AI assembly further comprises:
a speaker, electrically connected with the AI chip;
a microphone, electrically connected with the AI chip and configured to collect a voice and transmit a voice signal to the AI chip;
a first speech recognizing server, electrically connected with the AI chip and configured to recognize a processed voice signal sent from the AI chip and transmit a recognition result to the AI chip; and
a second speech recognizing server, electrically connected with the AI chip and configured to receive a first feedback from the AI chip and transmit a second feedback containing a sound signal to the speaker according to the first feedback, so that the accessory is capable of intelligently communicating with a user, wherein the AI chip is capable of sending instructions to the first air blowers and the speaker according to the voice signal to control operations of the first air blowers and the speaker.

15. The accessory according to claim 1, further comprising:
a battery; and
at least one solar panel configured to provide power to the battery.

16. The accessory according to claim 1, further comprising:
a main controller;
a sound system, electrically connected with the main controller;
a sound collecting member, electrically connected with the main controller, and configured to collect a voice and transmit a voice signal to the main controller;
a first speech recognizing server, electrically connected with the main controller and configured to recognize a processed voice signal of main controller and transmit a recognition result to the main controller;
a chip, electrically connected with the main controller and pre-storing vocabularies, the chip is configured to output a first feedback to the main controller according to the vocabularies and recognition result; and
a second speech recognizing server, electrically connected with the main controller and configured to receive the first feedback from the main controller and transmit a second feedback containing a sound signal to the sound system according to the first feedback, so that the accessory is capable of intelligently communicating with a user, wherein the main controller is capable of sending instructions to the first air blowers and the sound system according to the voice signal to control operations of the first air blowers and the sound system.

17. An inflatable doll comprising:
a body, comprising a cavity; and
an accessory, comprising:
at least one first air blower, comprising an air inlet portion and an air outlet portion communicated with the air inlet portion and the cavity; and
an AI assembly, electrically connected to the first air blower and configured to control the at least one first air blower to inflate or deflate the inflatable doll.

18. The inflatable doll according to claim 17, further comprising:
a plurality of expandable members, arranged in the cavity and connected with the body; and
a plurality of second air blowers, electrically connected with the AI assembly, the second air blowers are arranged on their respective expandable members and configured to direct air out of their respective expandable members, to move the expandable members and the inflatable doll dynamically.

19. The inflatable doll according to claim 18, wherein the AI assembly comprises:
an AI chip, electrically connected to the first air blowers and the second air blowers; and
at least one camera, electrically connected to the AI chip and arranged at the body; and
a speaker, electrically connected with the AI chip and arranged at the body.

20. An inflatable doll set, comprising a plurality of inflatable dolls, wherein each inflatable doll comprises:
a body, comprising a cavity; and
an accessory, comprising:
at least one first air blower, comprising an air inlet portion and an air outlet portion communicated with the air inlet portion and the cavity; and
an AI assembly, electrically connected to the first air blower and configured to control the at least one first air blower to inflate or deflate the inflatable doll.
